(19) United States
(12) Patent Application Publication
(10) Pub. No.: US 2006/0039136 A1
(43) Pub. Date: Feb. 23, 2006

(54) Lighted plug apparatus

(76) Inventors: Max A. Probasco, Plano, TX (US); Michael J. Green, Fort Worth, TX (US)

Correspondence Address: LAW OFFICES OF JAMES E. WALTON, PLLC, 1169 N. BURLESON BLVD., SUITE 107-328, BURLESON, TX, 76028, US

(21) Appl. No.: 11/030,340

(22) Filed: Jan. 6, 2005

Related U.S. Application Data
(60) Provisional application No. 60/603,197, filed on Aug. 20, 2004.

(51) Int. Cl. F21L 4/00; F21V 33/00; H01R 3/00

(52) U.S. Cl. 362/157; 362/253; 439/490

(57) ABSTRACT

An electrical plug has a housing with a forward face and has electrical conductors carried by the housing and adapted for conducting electrical energy through the housing. A lighting system is installed within the housing, the lighting system having a lighting element carried in the housing and oriented to emit light in a forward direction generally normal to the face. The lighting element is located above the face and recessed from the face. The lighting system also has an electrical power source for providing electrical power to the lighting element and a switch means for selectively operating the lighting element.

This application claims the benefit of U.S. Provisional Application No. 60/603,197, filed 20 Aug. 2004, and titled “Lighted Plug Apparatus.”

### BACKGROUND OF THE INVENTION

1. Field of the Invention

The invention relates to electrical plugs, and more particularly to plugs with incorporated lights and to lighting adapters for plugs.

2. Description of Related Art

Plugs are well known for use in electrical connections. Plugs are found on the end of extension cords as well as power cords on everything from lamps to power tools. Plugs are commonly found in either two prong or three prong configurations in the United States. The prongs form the “male” end of a connection and allow for safe connection with a “female” connector, such as an outlet or receptacle.

A common problem with plugs and receptacles is that they are sometimes difficult to use in dark areas. For safety, prongs are often arranged so that the male plug must be properly rotated relative to the female receptacle to make a proper connection. In a dark area it is difficult to see if the plug is properly aligned.

To remedy this situation some have tapped into the electricity available at the female connection to provide light in the vicinity of the female receptacle. This can solve the problem mentioned, but creates other problems, such as an annoying light in a darkened room and the waste of energy at the receptacle. Because the light is only needed when a plug is being inserted, a light built into the receptacle is on far more often than it is needed.

One idea has been to place a complex battery circuit mounted on a circuit board into the plug to provide light between the prongs of the plug. This adds significantly to the complexity of the plug and provides a field of illumination that is reduced by the shadows formed by the closely adjacent prongs.

### SUMMARY OF THE INVENTION

An electrical plug has a housing with a face and has electrical conductors carried by the housing and adapted for conducting electrical energy through the housing A lighting system is installed within the housing, the lighting system having a lighting element carried in the housing and oriented to emit light in a direction generally normal to the face. The lighting element is located above the face and recessed from the face. The lighting system also has an electrical power source for providing electrical power to the lighting element and a switch means for selectively operating the lighting element.

### BRIEF DESCRIPTION OF THE DRAWINGS

The novel features believed to be characteristic of the invention are set forth in the appended claims. However, the invention itself, as well as a preferred mode of use and further objectives and advantages thereof, will best be understood by reference to the following detailed description when read in conjunction with the accompanying drawings, wherein:

FIG. 1 is a perspective view of a lighted plug apparatus according to the present invention;

FIG. 2 is a perspective view of the electrically conductive elements of the apparatus of FIG. 1;

FIG. 3 is a partially exploded perspective view of the apparatus of FIG. 1;

FIG. 4 is sectional front view of a button used on the apparatus of FIG. 1;

FIG. 5 is a perspective view of a battery spacer used in the apparatus of FIG. 1;

FIG. 6 is a sectional side view of the apparatus of FIG. 1, the view showing the configuration of the operational elements for the lighting system of the apparatus;

FIG. 7 is a sectional front view of the apparatus of FIG. 1;

FIG. 8 is a perspective view of an alternative embodiment of a lighted plug apparatus according to the invention;

FIG. 9 is a perspective view of the electrically conductive elements of the apparatus of FIG. 8;

FIG. 10 is a rear view of the apparatus of FIG. 8;

FIG. 11 is partially exploded perspective view of the apparatus of FIG. 8;

FIG. 12 is a perspective view of another alternative embodiment of a lighted plug apparatus according to the invention;

FIG. 13 is a partially exploded perspective view of the apparatus of FIG. 12;

FIG. 14 is a perspective view of another alternative embodiment of a lighted plug apparatus according to the invention;

FIG. 15 is a perspective view of another alternative embodiment of a lighted plug apparatus according to the invention;

FIG. 16 is a perspective view of another alternative embodiment of a lighted plug apparatus according to the invention, the apparatus being configured for use with a power strip;

FIG. 17 is a perspective view of another alternative embodiment of a lighted plug apparatus according to the invention;

FIG. 18 is a perspective view of a lighted plug apparatus according to the invention and having a lighting element located on a longitudinal surface of the plug;

FIG. 19 is a perspective view of an assembly having a lighting system according to the invention and assembled with an electrical plug; and

FIG. 20 is a perspective view of an assembly having an alternative embodiment of the lighting system of FIG. 19 assembled with an electrical plug.

### DETAILED DESCRIPTION OF THE PREFERRED EMBODIMENT

The present invention represents the discovery that a simple lighting mechanism can provide lighting that allows for orientation of a plug prior to insertion of the plug into a receptacle that is located in a darkened area.

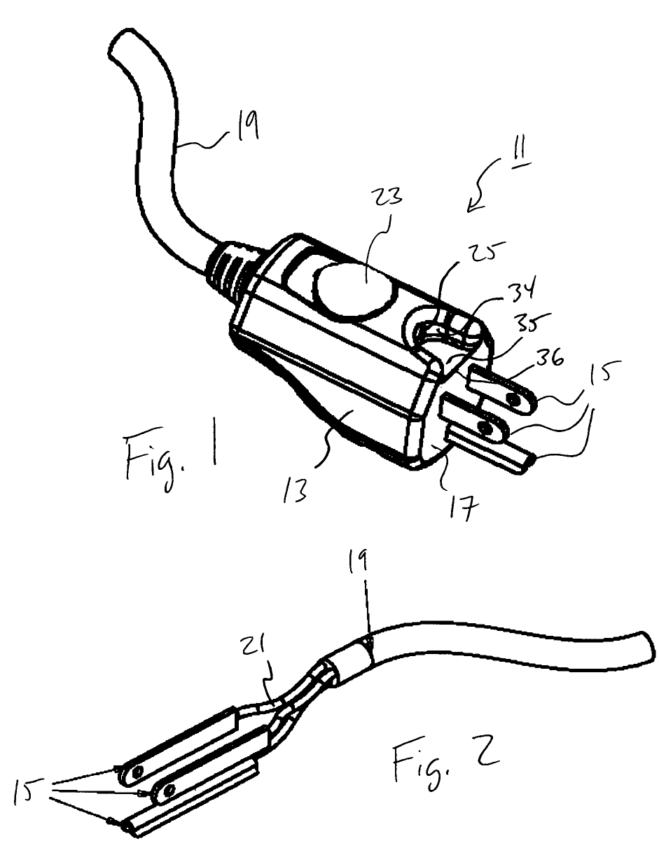

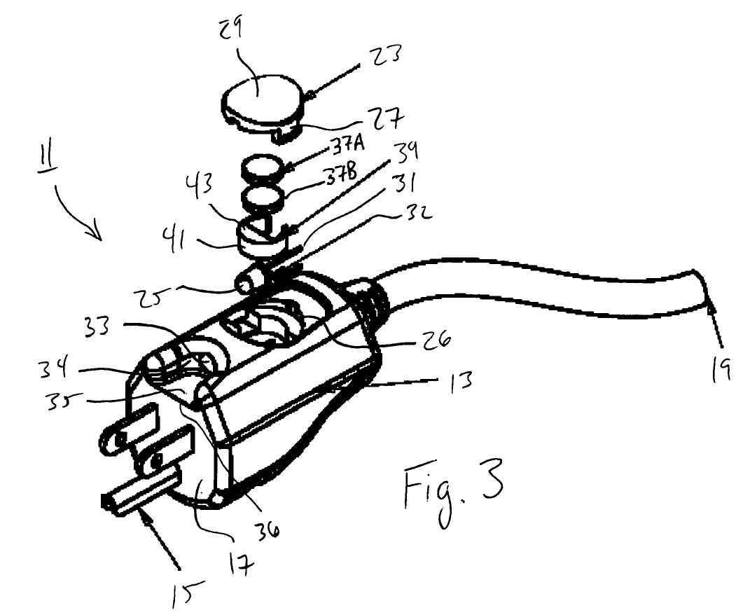

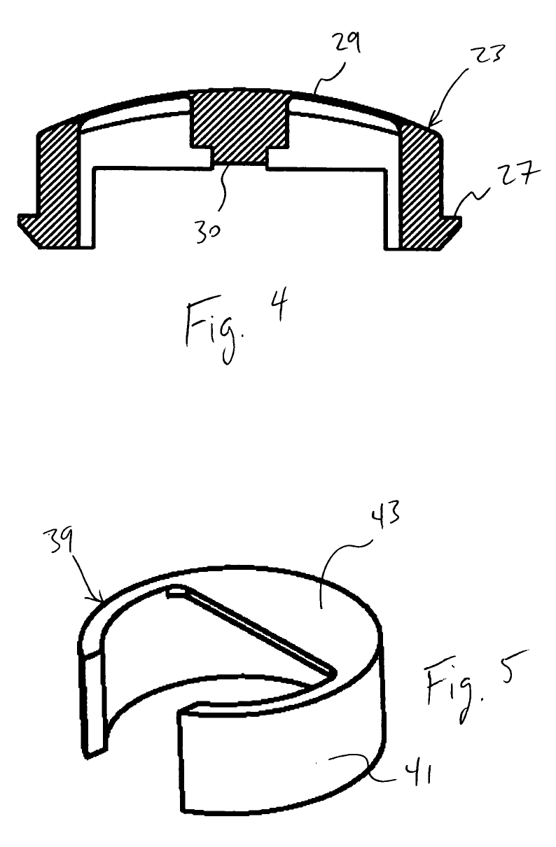

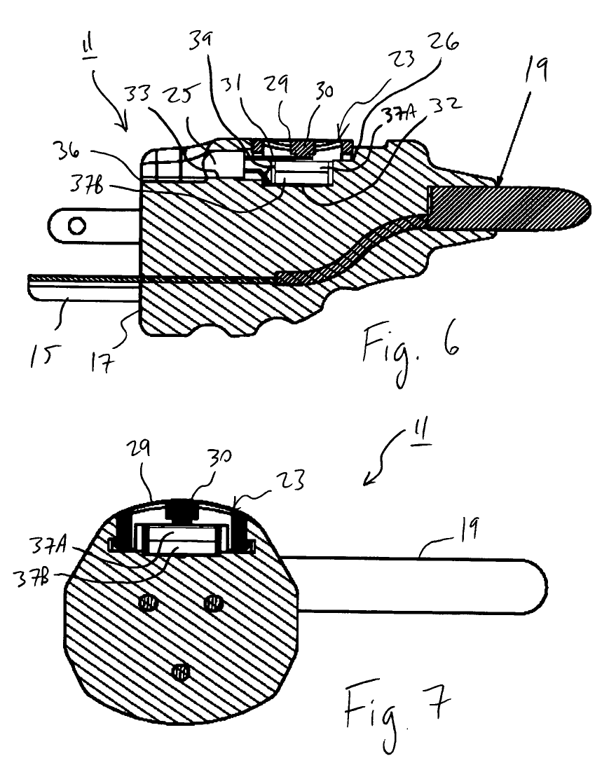

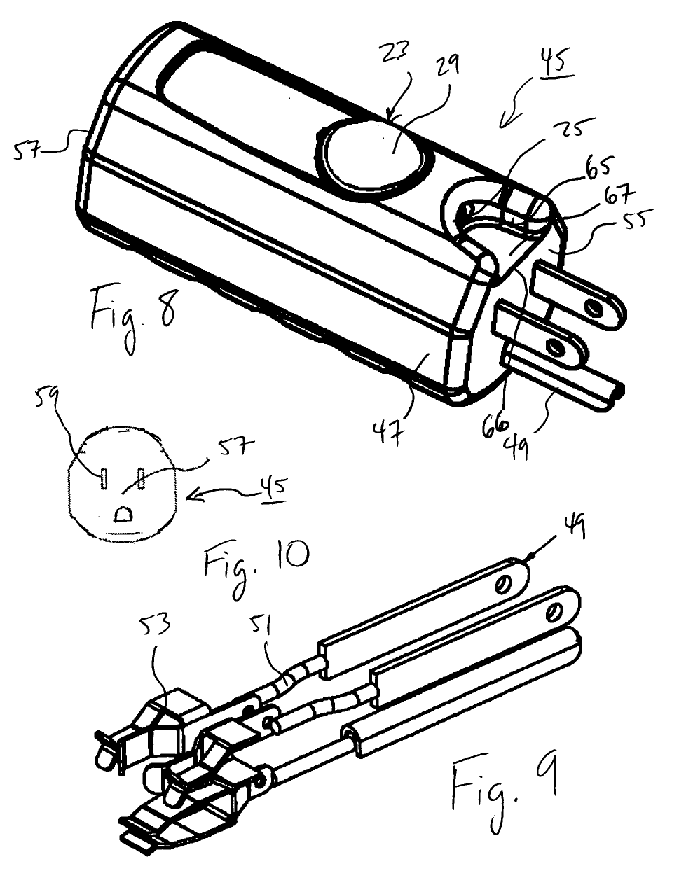

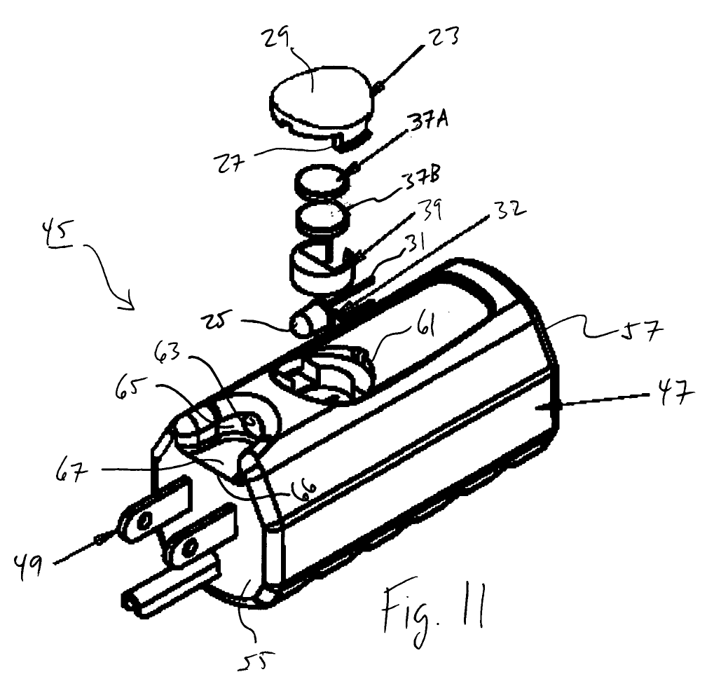

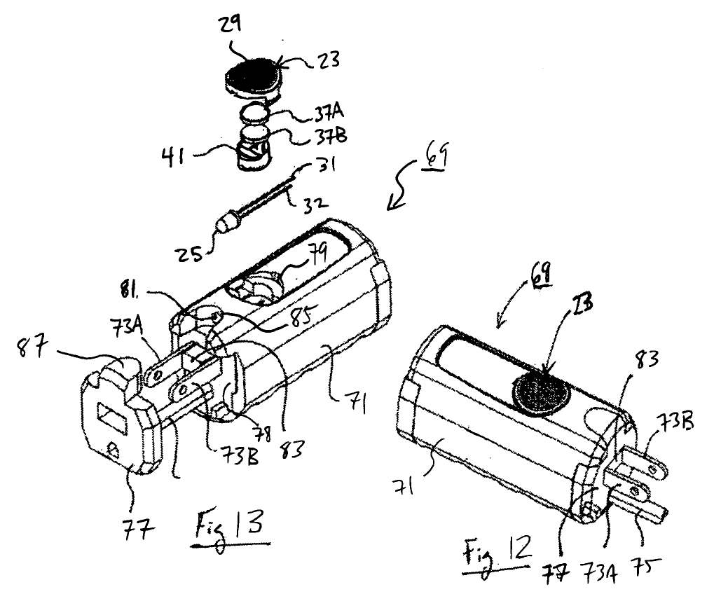

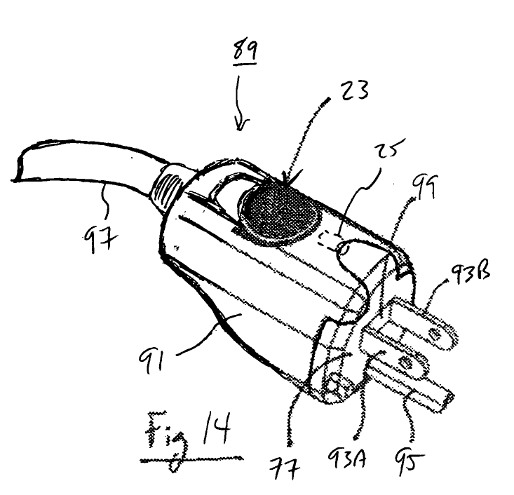

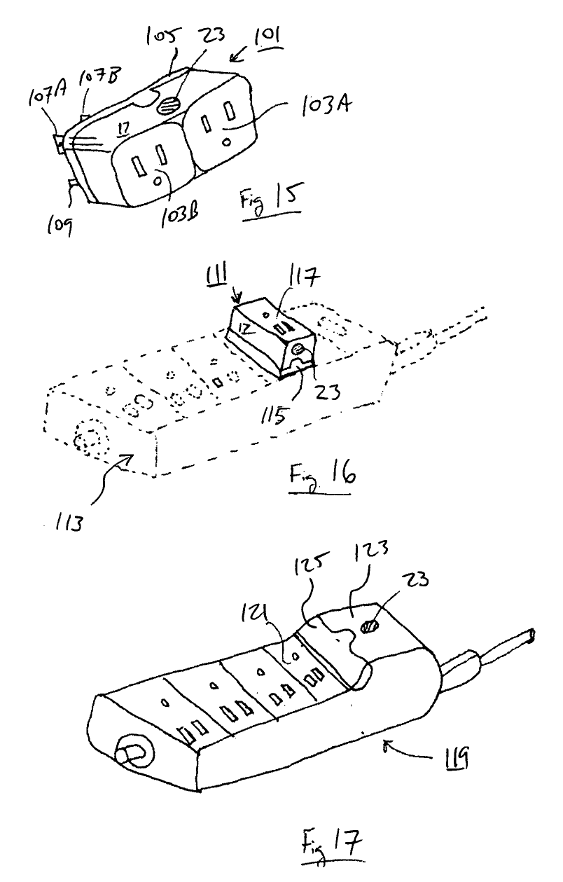

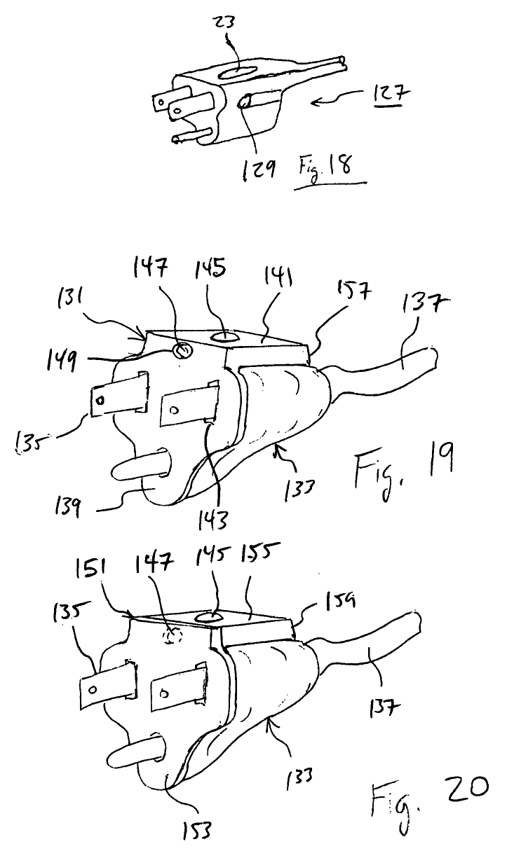

Referring to FIG. 1 and 2 in the drawings, an embodiment of a lighted plug 11 has a body 13 and male electrical conductors 15 extending from a transverse face 17 of body 13. Body 13 is formed of materials commonly used in the manufacture of electrical plugs, including plastic materials and hard rubber materials, the choice of material depending on the expected usage. An electrical cable 19 extends from the end of plug 11 opposite face 17. As shown in FIG. 2, cable 19 houses wires 21, and each wire 21 is conductively connected to one of conductors 15 for conducting electricity through conductors 15 and into wires 21. Body 13 may be molded onto the cable/conductors assembly of FIG. 2, or body may be a multi-piece housing affixed with fasteners or similar means. Plug 11 has a switch means, such as button 23 for operating a lighting element 25, which is carried in body 13 in a location recessed from face 17.

FIG. 3 is an exploded view of plug 11, showing parts for operating lighting element 25 that are located below button 23 and in cavity 26 of body 13. Button 23 is retained within body 13 by hooks 27 depending from button 23, hooks being configured for engaging slots or other features within cavity 26. Button 23 is formed from a flexible material, allowing for a user to deform button by pressing flexible member 29 of button 23 toward the interior of body 13. FIG. 4 is a cross-sectional view of button 23 showing a contact 30 depending from an inner surface of member 29, contact 30 moving with member 29 as the user depresses member 29.

Referring again to FIGS. 1 and 3, lighting element 25 may be any appropriate type, such as a light-emitting diode (LED), an organic LED, an incandescent bulb, a fluorescent bulb, a cold cathode-ray tube, or a neon bulb. Lighting element 25 has an upper electrical lead 31 and a lower electrical lead 32 extending from a rearward portion of lighting element 25. A forward portion of lighting element 25 extends though a longitudinal passage 33 in body 13, passage 33 extending from cavity 26 to a surface 34 recessed from face 17. Passage 33 is located above face 17 and is slightly spaced from surface 35, which extends rearward from top edge 36 of face 17. Surface 35 forms a landing, which acts as a focusing plane for light emitted from lighting element 25.

Lighting element 25 is operated using electrical power provided by batteries 37A, 37B. Batteries 37A, 37B are preferably “button batteries,” which are commonly used in watches and other small devices. Each battery 37A, 37B has a positive terminal and a negative terminal, each terminal being a face of each battery 37A, 37B. Batteries 37A, 37B are preferably oriented in a stacked arrangement within cavity 26 and are installed within a spacer 39, which retains batteries 37A, 37B in the stacked arrangement and prevents undesirable contact of other objects with batteries 37A, 37B. Spacer 39 is formed from an electrically insulating material, preferably a plastic, and is formed to have a cylindrical wall 41 and a surface 43 that extends radially inward from a portion of wall 41 and abuts outermost battery 37A. Spacer 39 is shown in close-up in FIG. 5, which illustrates that surface 43 has a minimal thickness.

FIGS. 6 and 7 show the arrangement of the components of the lighting system when installed in body 13. Batteries 37A, 37B are in a stacked arrangement within spacer 39, and this assembly is placed within cavity 26. Lighting element 25 is positioned in bore 33 in an orientation in which lighting element 25 emits light in a direction generally parallel to bore 33 for illuminating an area forward of face 17. Lower electrical lead 32 is positioned adjacent the battery 37B and may be conductively contacting a conductive face of battery 37B, which is either the negative of positive terminal of battery 37B. The opposite face of battery 37B is in conductive contact with the face of battery 37A that is the terminal of the opposite electrical sign. Upper electrical lead 31 is positioned near the other face of battery 37A, with lead 31 resting adjacent surface 43 of spacer 39. An end portion of lead 31 extends past the inner edge of surface 43. Surface 43 slightly spaces lead 31 from battery 37A, surface 43 being electrically non-conductive. Button 23 is located such that contact 30 is positioned adjacent or slightly spaced from the end portion of lead 31. In this non-contacting position, surface 43 prevents lead 43 from touching battery 37A, which would result in a completed circuit and allow electrical power to flow through lighting element 25.

To operate lighting element 25, a user depresses member 29 of button 23, causing contact 30 to deform the end portion of lead 31 toward battery 37A until lead 31 contacts battery 37A. If lead 32 is in contact with battery 37B, then the deformation of lead 31 completes the electrical circuit. If lead 32 is not already in contact with battery 37B, depressing button 23 will also causes lead 32 to contact battery 37B to complete the circuit. In alternative embodiment, other similar configurations may be used, such as a configuration in which lead 31 is attached to contact 30 of button 23. These configurations form a “momentary” switch, in which operation continues only as long as the user maintains pressure on button 23. A significant advantage to these types of switch means is that they are easy to assemble and inexpensive to produce. Another advantage of the configuration is that there is no need for a substrate, such as a circuit board or “breadboard,” to which the components of the lighting system must be attached prior to installation.

Another advantage of lighted plug 11 is that the location of lighting element 25 prevents light emitted by lighting element 25 from passing between conductors 15. Because lighting element 25 is located above face 17 and recessed from face 17, light directed at an angle toward conductors 15 impinges on surface 35. This prevents the creation of shadows in lateral directions caused by light passing from between conductors 15 when lighting element 25 is operated.

FIGS. 8 through 11 illustrate an alternative embodiment of a lighted plug according to the present invention. Lighted plug 45 is an adapter version, allowing a user attach plug 45 to an existing electrical cord, such as an extension cord, and have the utility of lighted plug 11, which is described above. Plug 45 has a body 47 housing electrical conductors, shown in FIG. 9, for conducting electricity though plug 45. Each male conductor 49 is connected by a wire 51 to a female conductor 53 located at the opposite end of plug 45. Body 47 is formed or assembled around this conductor assembly, such that male conductors protrude through face 55 of plug 45 and female conductors form a female receptacle in face 57 of plug 45. Face 57 has apertures 59 for allowing male conductors of an electrical cord to enter body 47 for engaging female conductors 53. Like plug 11 above, a button 23 is located on an outer surface of body 47 for allowing a user to selectively control the operation of a lighting element 25.

FIG. 11 is a partially exploded view of plug 45, showing the lighting system components that are installed within cavity 61 in body 47. Lighting element 25 is installed in bore 63, which extends from cavity 61 to surface 65. Surface 65 is recessed from face 55, and bore 63 is slightly spaced from recess surface 67. Surface 67 extends rearward from top edge 66 of face 55 and is a landing that acts as a focusing plane for light emitted from lighting element 25.

Referring to FIGS. 12 and 13 in the drawings, an embodiment of a plug 69 has a body 71 housing an electrical-conductor assembly such as that shown in FIG. 9. A pair of blade conductors 73A, 73B and a ground conductor 75 extend through a translucent face 77 fastened to the end face 78 of plug 69. Body 71 is formed of materials commonly used in the manufacture of plugs, including plastic materials and hard rubber materials, the choice of material depending on the expected usage. Translucent face 77 is formed of a preferably clear material to form a lens for diffusing light within translucent face 77 and around conductors 73A, 73B, 75. For example, translucent face 77 may be formed of polycarbonate or poly-acrylic, as well as from other appropriate clear materials known in the art. As in the embodiments shown above, plug 69 has a lighting system using the same components and installed in the same manner within cavity 79 of body 71. Lighting element 25 is installed in bore 89, which is recessed from end face 78 in recess 85. When translucent face 77 is installed on end face 78, a protruding portion 87 of translucent face 77 is received within recess 85, such that portion 87 abuts bore 81 for transmission of light from lighting element 25 into translucent face 77.

A block 83 between blade conductors 73A, 73B is preferably formed of an opaque material that does not allow light to be emitted from translucent face 77 between blade conductors 73A, 73B. Block 83 may only extend between blade conductors 73A, 73B, as shown in FIGS. 12 and 13, or may extend between all three conductors 73A, 73B, 75. Block 83 prevents formation of shadows that would be formed if light were emitted from between blade conductors 73A, 73B.

In FIG. 14, an alternative embodiment of plug 69 is shown. Lighted plug 89 is a corded version having a body 91 surrounding an electrical-conductor assembly like that shown in FIG. 2. Blade conductors 93A, 93B and ground conductor 95 are conductively connected to wires within cable 97, and body 91 may be formed or assembled around the conductor assembly. A lighting system is carried within body 91, and the lighting system comprises the same components as the embodiments described above. Like plug 69 of FIG. 12, plug 89 has a translucent face 77 for transmitting light from lighting element 25 across face 77. A block 99 prevents light from passing between blade connectors 93A, 93B.

A multi-receptacle plug 101, which is a version of plug 69 of FIG. 12, is shown in FIG. 15. Button 23 is centered relative to two female receptacles 103A, 103B, and translucent face 105 extends across the complete face of multi-receptacle plug 101, providing a wide field of illumination around male conductors 107A, 107B, 109.

Referring now to FIG. 16 of the drawings, another alternate embodiment of plug 69 is shown, in which a plug 111 is adapted for use on electrical power strips, such as power strip 113. Plug 111 may be more compact in this version, and button 23 is shown on the top of plug 111. Face 115 extends to the sides of plug 111, and a lighting element within plug 111 emits light into face 115. The lighting element is oriented to ensure that the emitted light is cast from the sides of face 115, providing illumination of power strip receptacles located to either side of plug 113. A female receptacle 117 provides for connection of electrical devices to plug 111.

FIG. 17 illustrates a lighted power strip 119 having multiple female receptacles 121. A lighting element (not shown) is located within a housing 123 of power strip 119 and positioned to emit light into light-diffusing face 125, which is generally adjacent the lighting element. Depressing button 23 causes the lighting element to operate, providing illumination down the length of power strip 119.

In FIG. 18, a plug 127 is shown with a lighting element 129 located on a longitudinal surface of plug 127. For example, lighting element 129 may be located on the side of plug 127, as shown, or may alternatively be located on the top or bottom of plug 127. In addition, more than one lighting element may be used in one location on plug 127 and/or more than one location on plug 127. A power source (not shown), such as a battery carried within the housing or located remote from the housing, is used to provide electrical power to lighting element 129, and button 23 is used to operate lighting element 129.

FIGS. 19 and 20 illustrate a lighting system for electrical plugs that is attachable to any plug having a typical two- or three-prong configuration. Referring to FIG. 19, a lighting adapter 131 is assembled onto plug 133. As shown, plug 133 has three male conductors 135 extending from one end of plug 133, and conductors 135 are conductively connected to wires (not shown) within cord 137. Adapter 131 comprises a plate 139 and a housing 141, housing 141 preferably being mounted to an upper end of plate 139 and oriented to extend generally perpendicularly relative to plate 139. Plate 139 has apertures 143 for receiving male conductors 135. In the configuration shown, when adapter 131 is assembled onto plug 133, housing 141 is located adjacent an upper surface of plug 133, and plate 139 is located adjacent a front surface of plug 133. Plate 139 is preferably formed from the same material as housing 141, and plate 139 may be formed as an integral portion of housing 141. Housing 141 preferably carries an electrical power source (not shown), such as a button battery, and a switch 145 for selectively connecting the power source to a lighting element 147 located in a forward portion of housing 141. Alternatively, the power source for powering lighting element 147 may be located remote from housing 141. Lighting element 147 may be any appropriate type of lighting device, such as a LED, organic LED, fluorescent bulb, incandescent bulb, or a cold cathode-ray tube. When switch 145 is actuated, lighting element 147 emits light forward through an aperture 149 in housing 141 and in a direction generally parallel to conductors 135, whereby a user can selectively illuminate an area near conductors 135 for allowing easier orientation of plug 133 for insertion of conductors 135 into an electrical receptacle. Adapter 131 preferably remains assembled with plug 133 after connection of plug 133 to the receptacle, though apertures 143 may alternatively be formed as open-ended slots to allow removal of adapter 131 after insertion of plug 133 into a receptacle.

FIG. 20 shows an alternative embodiment of an adapter 151 assembled on plug 133. Adapter 151 has a face 153 formed from a translucent material, lighting element 147 being located in housing 155 and adjacent face 153. When switch 145 is actuated, lighting element 147 emits light forward into face 153, and the light is diffused within face 153 and around conductors 135 for illuminating an area near conductors 135.

Referring again to FIG. 19 and to FIG. 20, housings 141 and 155 may be formed from a translucent material. This allows light emitted from lighting element 147 to pass through or be diffused within housings 141 and 155 for lighting rearward surface of each, which are 157 159, respectively. Visual indicia (not shown) may be located on surfaces 157, 159 for being backlit by the light passing therethrough, and the indicia may be text or other graphics for identifying the electrical device receiving power through plug 133 and cord 137.

In addition, a second lighting element (not shown) may be located in a rear portion of housing 141 or 155 for illuminating surfaces 157 or 159. While the second lighting element may be selectively operated by switch 145 and powered by the same power source as lighting element 147, the second lighting element may alternatively be powered by electricity conducted from a receptacle through conductors 135. The electricity would preferably be conducted to the second lighting element through conductors within or adjacent plates 139 or 153 and in contact with conductors 135.

While shown in the figures as being used with a three-prong plug, embodiments of the lighted plug apparatus of the invention may be used with two-prong plugs or alternatively may be configured for use with two-prong plugs. The two-prong plug version (not shown) is preferably configured to also allow use of the two-prong version on a three-prong plug. Also, embodiments of the invention may be formed to have a low-profile, 90-degree configuration.

In addition, the switch means in all embodiments may be configured to have the ability to be locked in the “on” position, allowing a user to selectively turn on the lighting element of the plug for an extended time without the need to maintain pressure on the switch means. This feature may be implemented in any appropriate way, such as with sliding or rotating means.

Other embodiments of the invention may have a remotely located power source used for powering the lighting element. For example, a battery or other power source may be located within an appliance and be connected to the lighting element with a conductor located within or adjacent the electrical cord connected to the plug.

It is apparent that an invention with significant advantages has been described and illustrated. Although the present invention is shown in a limited number of forms, it is not limited to just these forms, but is amenable to various changes and modifications without departing from the spirit thereof.

We claim:

1. An electrical plug, comprising:
a housing with a forward face having a top edge;
electrical conductors carried by the housing and adapted for conducting electrical energy through the housing; and
a lighting system, comprising:
a lighting element carried in the housing and oriented to emit light in a forward direction generally normal to the face, the lighting element being located above the top edge of the face;
an electrical power source for providing electrical power to the lighting element; and
a switch means for selectively operating the lighting element.

2. The plug according to claim 1, wherein the lighting element is a type selected from the group consisting of a light-emitting diode, an organic light-emitting diode, an incandescent bulb, a fluorescent bulb, a cold cathode-ray tube, and a neon bulb.

3. The plug according to claim 1, wherein the conductors comprise at least a pair of male conductors, the male conductors extending from the face of the housing.

4. The plug according to claim 3, further comprising:
female conductors located in the housing and conductively connected to the male conductors.

5. The plug according to claim 3, further comprising:
a cord extending from the housing and containing conductive wires, the wires being conductively connected to the male conductors.

6. The plug according to claim 1, wherein the electrical power source comprises at least one battery.

7. The plug according to claim 1, wherein the lighting system further comprises:
two electrical leads extending from the lighting element;
wherein the switch means is configured to cause contact between each lead and a terminal of the battery when the switch means is actuated, the contact allowing electrical energy to flow from the battery and through the leads for operating the lighting element.

8. The plug according to claim 7 wherein the lighting system further comprises:
a spacer for preventing contact of at least one of the leads prior to actuation of the switch means.

9. The plug according to claim 1 i wherein the lighting system further comprises:
means for operating the lighting element in a continuous manner.

10. The plug according to claim 1, further comprising:
a focusing plane extending rearward from the top edge of the face and generally perpendicular to the face, the lighting element being located above the focusing plane.

11. The plug according to claim 1, wherein the lighting system is configured to be installed without prior assembly on a substrate.

12. An electrical plug, comprising:
a housing;
male conductors extending from the housing;
a light-diffusing face surrounding at least one of the male conductors;
a lighting element oriented to emit light into the face for illuminating an area near the male conductors;
an electrical power source for providing electrical power to the lighting element; and
a switch means for selectively operating the lighting element.

13. The plug according to claim 12, wherein the lighting element is a type selected from the group consisting of a light-emitting diode, an organic light-emitting diode, an incandescent bulb, a fluorescent bulb, a cold cathode-ray tube, and a neon bulb.

14. The plug according to claim 12, further comprising:
female conductors located in the housing and conductively connected to the male conductors.

15. The plug according to claim 12, further comprising:
a cord extending from the housing and containing conductive wires, the wires being conductively connected to the male conductors.

16. An electrical plug, comprising:
a housing extending in a longitudinal direction;
male conductors extending from the housing in the longitudinal direction;
at least one lighting element positioned on an outer surface of the housing, the outer surface extending in the longitudinal direction, the lighting element being oriented to emit light substantially parallel to the outer surface in the longitudinal direction for illuminating an area near the male conductors;
an electrical power source for providing electrical power to the at least one lighting element; and
a switch means for selectively operating the at least one lighting element.

17. The electrical plug according to claim 16, wherein no light shines between the male conductors.

18. A lighting apparatus for an electrical plug having male conductors extending therefrom, the lighting apparatus comprising:
a thin plate adapted to receive the male conductors for securing the thin plate relative to the plug;
a housing attached to the plate; and
a lighting element disposed within the housing for illuminating an area near the male conductors.

19. The lighting apparatus according to claim 18, further comprising:
an electrical power source carried within the housing.

20. The lighting apparatus according to claim 18, wherein the plate is formed from a light-transmitting material and the lighting element emits light into the plate for illuminating the area.

21. The lighting apparatus according to claim 18, wherein the housing includes a translucent portion for allowing light from the lighting element to pass therethrough.

22. The lighting apparatus according to claim 21, wherein the translucent portion includes visual indicia that is backlit by the lighting element.

23. The lighting apparatus according to claim 18, wherein the lighting element is adapted to be powered by electricity conducted through the male conductors.

24. An electrical power strip, comprising:
a housing;
a plurality of electrical receptacles in the housing;
a light-diffusing face positioned near the receptacles;
a lighting element oriented to emit light into the face for illuminating the receptacles;
an electrical power source for providing power to the lighting element; and
a switch means for selectively operating the lighting element.
